(19) United States
(12) Patent Application Publication
(10) Pub. No.: US 2016/0299632 A1
(43) Pub. Date: Oct. 13, 2016

(54) METHOD AND DEVICE FOR IMPLEMENTING A TOUCH INTERFACE

(71) Applicant: Edan Instruments, Inc., Shenzen, Guangdong (CN)

(72) Inventors: Jun Liu, Shenzhen, Guangdong (CN); Jianfeng Du, Shenzhen, Guangdong (CN); Chuanxi Guo, Shenzhen, Guangdong (CN)

(21) Appl. No.: 15/038,537

(22) PCT Filed: Dec. 24, 2013
(86) PCT No.: PCT/CN2013/090296

§ 371 Date: May 23, 2016

(30) Foreign Application Priority Data
Dec. 16, 2013 (CN) 201310685355.4

(51) Int. Cl. G06F 3/041; G06F 3/0488; G06F 3/0481

(52) U.S. Cl. CPC G06F 3/0418; G06F 3/04817; G06F 3/0488

(57) ABSTRACT

The present invention relates to a method and a device for implementing a touch interface, wherein an icon display area and a transparent area are set on a control area, the transparent area is arranged around the icon display area. The method allows a touch device enlarges an actual area of an icon without expanding or modifying the icon, which improves the accuracy of a touch screen during use, and overcomes the technical problem that only using the screen made of high-resolution, high-precision, and highly sensitive advanced material can improve the performance of the touch screen; thereby reducing the production cost, and increasing the usability of products. The device implementing the method for implementing a touch interface which corresponds to the method of the present invention also has the same advantages.

### TECHNICAL FIELD

The invention relates to a method for implementing a user interface, especially relates to a method and a device for implementing a touch interface and a device for implementing the method.

### BACKGROUND

At present, operating application which runs on some small touch-screen device, usually comprises the following approaches: one is clicking on the desired touch control to execute the command, however, this method has the disadvantage that: the physical area of the touch control is too small on the small touch-screen device, the peripheral button may be touched incorrectly when the corresponding touch control area is touched, which leads to low touch accuracy; another is adding a background to the icon or directly enlarging the physical area of the icon, and clicking on the icon to execute the corresponding command The defect is that: more real area of the screen will be occupied, the production cost increases. Another method is shrinking the icon button, popping up the enlarged icon when the small button is inducted, clicking the enlarged icon to execute commands, such as the patent with the title “touch control system and control method” and publication number CN101930338 A. the disadvantages of such method is that: the operation is complicated, and an accidental contact may be easily caused when the small button is clicked; and a still another method is using a high-end touch screen as much as possible such as high resolution, high sensitivity, or high sensitivity sensor chip, to ensure touch accuracy. The disadvantage is that the production cost increases.

### SUMMARY

The present invention aims at providing a method for implementing a touch interface, which can still ensure touch accuracy even in a small touch device and doesn't need to increase too much production cost.

Provided is a method for implementing a touch interface, comprising the following steps:

establishing a coordinate system in the screen;

setting one or more than one control areas on the screen according to the coordinate system;

setting an icon display area and/or a non-icon display area on the control area, and arranging the non-icon display area around the icon display area;

establishing a corresponding control item for the icon display area and the non-icon display area and setting a corresponding command for the control item;

executing the corresponding command respectively if touch operations happen within the coordinates of the icon display area and the non-icon display area.

Furthermore, in the step of executing the corresponding command respectively if touch operations happen within the coordinates of the icon display area and the non-icon display area, the command corresponding to the non-icon display area is the same as or different from the command corresponding to the icon display area.

Furthermore, after the step of setting an icon display area and/or a non-icon display area on the control area, and arranging the non-icon display area around the icon display area, the method further comprises overlapping the non-icon display areas of adjacent control areas.

Still further, after the step of overlapping the non-icon display areas of adjacent control areas, the method further comprises setting the number of the non-icon display area larger than or equal to 1 in one control area, and hierarchically arranging the non-icon display areas centered around the icon display area.

Still further, after the step of setting the number of the non-icon display area larger than or equal to 1 in one control area, and hierarchically arranging the non-icon display area centered around the icon display area, the method comprises setting a maximum width of the non-icon display area being a minimum distance between two adjacent icon display areas.

As an improvement, the step of executing the corresponding command respectively if touch operations happen within the coordinates of the icon display area and the non-icon display area comprises:

collecting touch coordinates when the touch operation happens in the control area;

determining in which control area does the touch operation happen according to a minimum distance of the distances between the touch coordinates and the geometric centers of the adjacent control areas;

executing the command corresponding to the icon display area if the command corresponding to the non-icon display area is the same as the command corresponding to the icon display area; and

determining a specific area where the touch operation happens according to the touch coordinates and executing the corresponding command if the command corresponding to the non-icon display area is different from the command corresponding to the icon display area.

Furthermore, the step of determining in which control area does the touch operation happen according to a minimum distance of the distances between the touch coordinates and the geometric centers of the adjacent control areas comprises:

prompting implementing the touch operation again if the number of the minimum distance is equal to or larger than 2.

Still further, in the step of prompting implementing the touch operation again if the compared control areas contain the same coordinates, the prompt comprises: a text prompt, a picture prompt, a sound prompt, a vibration prompt and so on.

Still further, in the step executing the corresponding command respectively if touch operations happen within the coordinate ranges of the icon display area and the non-icon display area, the touch operation comprises: a single click, a double click, and a sliding; for the sliding operation, after the control area is pressed, if the user slide out of the control area and then slide in the control area, or slide of the control area directly, the command corresponding to the control area is not executed.

In addition, provided is a touch interface device comprising:

a display module, configured to provide a display area and screen coordinates and receive a touch operation;

a control module, connected with the display module and configured to control an area division, an image output and a display area arrangement of the display module;

a programming module, respectively connected to the display module and the control module and configured to store and execute a command program, wherein the programming module receives the touch coordinates sent by the display module and execute the command corresponding to a control item according to the touch coordinates, and operate the control module;

wherein the display module comprises:
a screen unit, configured to display icons and data information and receive the touch operation;
a coordinate unit, connected with the screen unit and configured to establish a coordinate system for the screen unit, collect touch coordinates and output the touch coordinates;
a communication unit, respectively connected to the coordinate unit, the control module and the programming unit and configured to provide a data link to the coordinate unit, the control module and the programming unit; and
a driving unit, configured to drive the screen unit to display icons and data information;

the control module comprises:
an area unit configured to divide the display module into a control area, an icon display area and a non-icon display area according to the coordinate system; and
the communication unit, respectively connected to the area unit, the programming unit and the display module and configured to provide the data link to the area unit, the programming unit and the display module;

the programming unit comprises:
a storage unit, configured to store the control item and the command;
an executing unit, connected to the storage unit and configured to execute the corresponding command stored in the storage unit according to the touch coordinates collected by the display module and coordinate ranges of the control area, the icon display area and the non-icon display area divided by the control module; and

the communication unit, respectively connected to the executing unit, the control module and the display module and configured to provide the data link to the executing unit, the control module and the display module.

As an improvement, the control module further comprises a hierarchy judging unit configured to set and judge the non-icon display areas arranged hierarchically in the adjacent control areas.

Furthermore, the programming module further comprises a coordinate processing unit configured to calculate coordinates of a geometric center, and control and judge a touch operation.

In the method for implementing a touch interface of the present invention, the transparent area for separating adjacent icon display areas is linked to the icon display area surrounded by the transparent area, when the touch operation happen in the transparent area, that is equivalent to the touch operation happening in the icon display area, then the corresponding function of the icon area is activated, which enlarges an actual area of an icon without expanding the area of the screen or introducing a touch chip with higher level, thereby improving the touch accuracy, and overcoming the defect existing in the prior art. The device implementing the method of the present invention also has the same advantages.

### BRIEF DESCRIPTION OF THE DRAWINGS

For ease of illustration, the present invention is described in detail by the following embodiments and the accompanying drawing.

FIG. 1 illustrates the main steps of the method for implementing a touch interface of the present invention;

FIG. 2 illustrates the specific steps of the method for implementing a touch interface of the present invention;

FIG. 3 is the schematic diagram of applying the method for implementing a touch interface of the present invention;

FIG. 4 is the schematic diagram of the control area in normal state in the method for implementing a touch interface of the present invention;

FIG. 5 is the schematic diagram of the control area in operation state in the method for implementing a touch interface of the present invention;

FIG. 6 is the schematic diagram of the basis structure of the control area in the method for implementing a touch interface of the present invention;

FIG. 7 is the schematic diagram of the structure of a single control area in the method for implementing a touch interface of the present invention;

FIG. 8 is the schematic diagram of the basic structure of the device implementing the method for implementing a touch interface of the present invention;

FIG. 9 the schematic diagram of the improved structure of the device implementing the method for implementing a touch interface of the present invention.

### DESCRIPTION OF EMBODIMENTS

To make the objectives, technical solutions, and advantages of the present invention clearer, the following further describes the present invention in detail with reference to the accompanying drawings and embodiments.

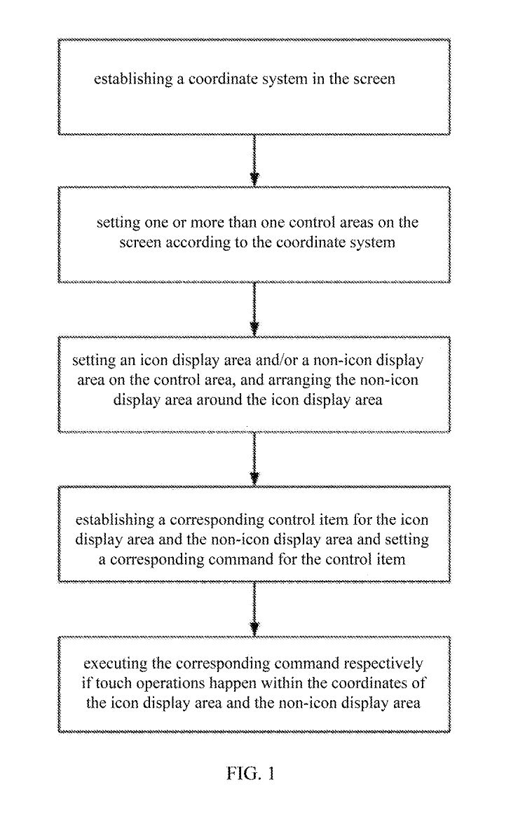

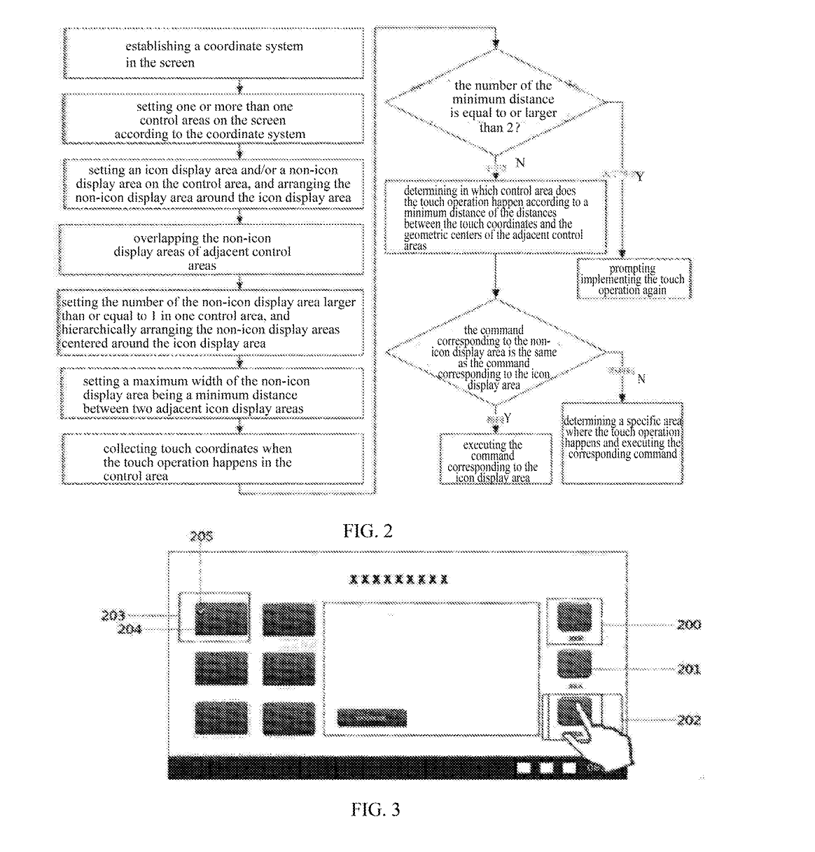

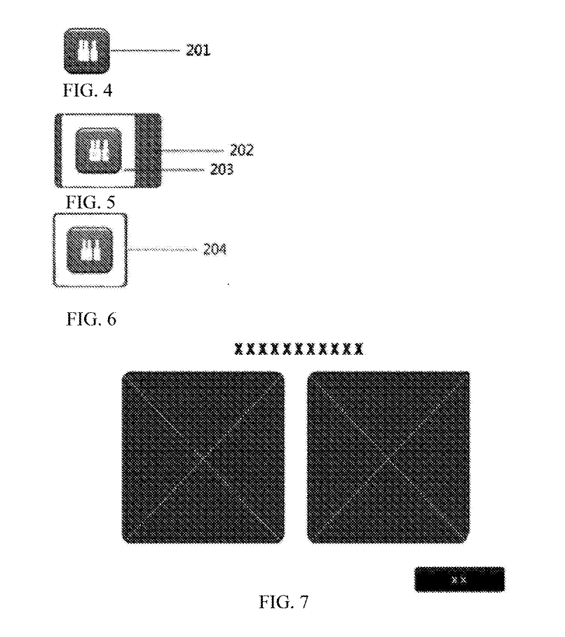

As shown in FIGS. 1-9, the method for implementing a touch interface comprises the following steps:

establishing a coordinate system in the screen by the display module;

setting one or more than one control areas on the screen according to the coordinate system by the control module;

setting an icon display area and/or a non-icon display area on the control area, and arranging the non-icon display area around the icon display area by the control module;

establishing a corresponding control item for the icon display area and the non-icon display area and setting a corresponding command for the control item by the programming module;

executing the corresponding command respectively if touch operations happen within the coordinates of the icon display area and the non-icon display area of the display module by the programming module.

Furthermore, in the step of executing the corresponding command respectively if touch operations happen within the coordinates of the icon display area and the non-icon display area of the display module by the programming module, the command corresponding to the non-icon display area is the same as or different from the command corresponding to the icon display area.

Furthermore, after the step of setting an icon display area and/or a non-icon display area on the control area, and arranging the non-icon display area around the icon display area by the control module, the method further comprises overlapping the non-icon display areas of adjacent control areas in the screen of the display module.

Still further, after the step of overlapping the non-icon display areas of adjacent control areas in the screen by the display module, the method further comprises setting the number of the non-icon display area larger than or equal to 1 in one control area, and hierarchically arranging the non-icon display areas centered around the icon display area in the display module.

Still further, after the step of setting the number of the non-icon display area larger than or equal to 1 in one control area, and hierarchically arranging the non-icon display area centered around the icon display area in the display module, the method comprises setting a maximum width of the non-icon display area being a minimum distance between two adjacent icon display areas in the display module.

Still further, the step of executing the corresponding command respectively if touch operations happen within the coordinates of the icon display area and the non-icon display area in the display module comprises:

collecting touch coordinates when the touch operation happens in the control area by the display module;

determining in which control area does the touch operation happen according to a minimum distance of the distances between the touch coordinates and the geometric centers of the adjacent control areas by the programming module;

executing the command corresponding to the icon display area if the command corresponding to the non-icon display area is the same as the command corresponding to the icon display area; and

determining a specific area where the touch operation happens according to the touch coordinates and executing the corresponding command if the command corresponding to the non-icon display area is different from the command corresponding to the icon display area.

Furthermore, the step of determining in which control area does the touch operation happen according to a minimum distance of the distances between the touch coordinates and the geometric centers of the adjacent control areas by the programming module comprises:

prompting implementing the touch operation again if the number of the minimum distance is equal to or larger than 2 by the programming module.

As an improvement, in the step of prompting implementing the touch operation again by the programming module if the compared control areas contain the same coordinates, the prompt comprises: a text prompt, a picture prompt, a sound prompt, a vibration prompt and so on.

Still further, in the step executing the corresponding command respectively if touch operations happen within the coordinate ranges of the icon display area and the non-icon display area, the touch operation comprises: a single click, a double click, and a sliding; for the sliding operation, after the control area is pressed, if the user slide out of the control area and then slide in the control area, or slide of the control area directly, the command corresponding to the control area is not executed.

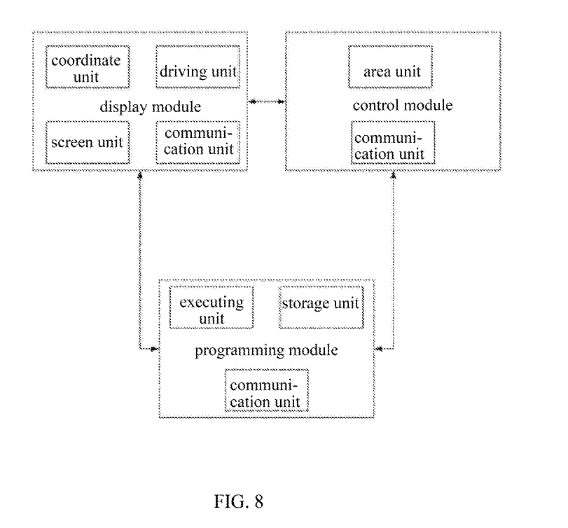

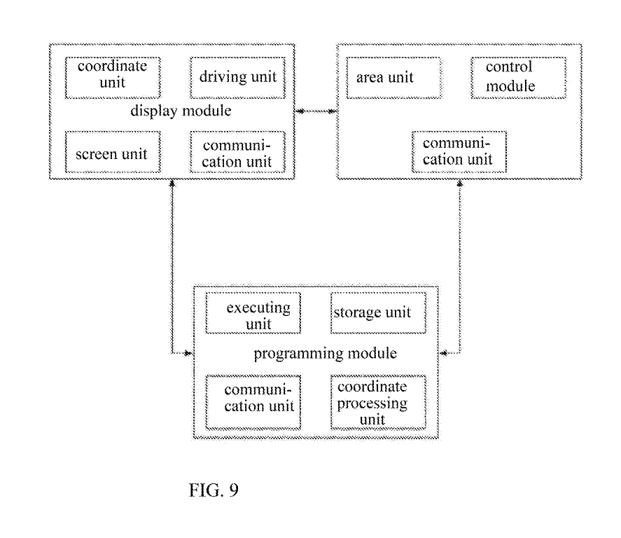

As shown in FIGS. 8-9, a touch interface device comprises:

a display module, configured to provide a display area and screen coordinates and receive a touch operation;

a control module, connected with the display module and configured to control an area division, an image output and a display area arrangement of the display module;

a programming module, respectively connected to the display module and the control module and configured to store and execute a command program, wherein the programming module receives the touch coordinates sent by the display module and execute the command corresponding to a control item according to the touch coordinates, and operate the control module;

wherein the display module comprises:
a screen unit, configured to display icons and data information and receive the touch operation;
a coordinate unit, connected with the screen unit and configured to establish a coordinate system for the screen unit, collect touch coordinates and output the touch coordinates;
a communication unit, respectively connected to the coordinate unit, the control module and the programming unit and configured to provide a data link to the coordinate unit, the control module and the programming unit; and
a driving unit, configured to drive the screen unit to display icons and data information;

the control module comprises:
an area unit configured to divide the display module into a control area, an icon display area and a non-icon display area according to the coordinate system; and
the communication unit, respectively connected to the area unit, the programming unit and the display module and configured to provide the data link to the area unit, the programming unit and the display module;

the programming unit comprises:
a storage unit, configured to store the control item and the command;
an executing unit, connected to the storage unit and configured to execute the corresponding command stored in the storage unit according to the touch coordinates collected by the display module and coordinate ranges of the control area, the icon display area and the non-icon display area divided by the control module; and

the communication unit, respectively connected to the executing unit, the control module and the display module and configured to provide the data link to the executing unit, the control module and the display module.

As an improvement, the control module further comprises a hierarchy judging unit configured to set and judge the non-icon display areas arranged hierarchically in the adjacent control areas, hierarchically arrange the non-icon display areas centered around the icon display area according requirement and setting different commands for the non-icon display areas.

Furthermore, the programming module further comprises a coordinate processing unit configured to calculate the coordinate of a geometric center, and control and judge a touch operation. The coordinate processing unit calculates the coordinate of the geometric center of the touch according to the touch coordinates collected by the display module, calculates the coordinate of the geometric center of the control area according to the coordinate range of the control area, and makes determination according to the coordinates of the geometric centers.

Specifically, as shown in FIGS. 3-6, FIG. 3 is an example of the wide application of the present invention. From inside to outside, the control area comprises areas 201, 203 and 202. The area 201 is the icon display area, the area 203 is a first non-icon display area outside the area 201, and the area 202 is a second non-icon display area outside the area 20. 200 is the state of the icon display area when the icon display area is touched, that is the state after the icon display area receives the touch operation. 204 is the whole control area. The area 205 is the small icon area to be checked in the prior art. When the user touches the icon display area in the control area, the icon display area displays 201 instead of 200, which prompts the system starts to response. If the screen of the display module or the icon is too small such that the user touch on the area outside coordinates of the icon display area, such as non-icon area 202 or 203, the icon display area also responses and enters in the state 200. It does not need to improve the hardware settings or increase the display area, while improves the accuracy of the small touch screen devices, and reduces the touch area false operation caused by small touch area. The display module may set the width and the hierarchy of the non-icon display area according to the available area the icon display area and the distance between adjacent icon display areas. In the prior art, such as the area 205 that needs to be checked is relatively small, in the small touch screen devices, the area 205 is difficult to accurately touch, thereby leading to no response from the system. In the present invention, the programming module can arrange the non-icon display areas hierarchically, set different commands for the non-icon display areas with different hierarchies, and equate the command of one non-icon display area to the command of the area 205 to be checked, when such non-icon display area is touched, it is equivalent to the area 205 to be checked being touched, the command corresponding to the small area 205 to be checked may be executed, and the area 205 is checked. As shown in FIG. 7, the rectangle marked with XX at the bottom right corner is the control area, i.e. the button icon, the black rectangle in the middle is a content display area. As one embodiment of the present invention, for the convenience of the touch operation, the control module only set one control area in the screen of the display module, or cancel the visible icon display area, directly set the non-icon display area on a presentation area or blank area, or other screen area that can be used to touch, which facilitates user's operation during browse.

The foregoing descriptions are merely exemplary embodiment of the present invention, but are not intended to limit the present invention to it. Any modification, equivalent replacement, or improvement made without departing from the spirit and principle of the present invention shall fall within the protection scope of the present invention.

What is claimed is:

1. A method for implementing a touch interface, comprising the following steps:
establishing a coordinate system in the screen;
setting one or more than one control areas on the screen according to the coordinate system;
setting an icon display area and/or a non-icon display area on the control area, and arranging the non-icon display area around the icon display area;
establishing a corresponding control item for the icon display area and the non-icon display area and setting a corresponding command for the control item;
executing the corresponding command respectively if touch operations happen within the coordinate ranges of the icon display area and the non-icon display area.

2. The method for implementing a touch interface of claim 1, wherein in the step of executing the corresponding command respectively if touch operations happen within the coordinates of the icon display area and the non-icon display area, the command corresponding to the non-icon display area is the same as or different from the command corresponding to the icon display area.

3. The method for implementing a touch interface of claim 2, wherein after the step of setting an icon display area and/or a non-icon display area on the control area, and arranging the non-icon display area around the icon display area, the method further comprises overlapping the non-icon display areas of adjacent control areas.

4. The method for implementing a touch interface of claim 2, wherein after the step of overlapping the non-icon display areas of adjacent control areas, the method further comprises setting the number of the non-icon display area larger than or equal to 1 in one control area, and hierarchically arranging the non-icon display areas centered around the icon display area.

5. The method for implementing a touch interface of claim 4, wherein after the step of setting the number of the non-icon display area larger than or equal to 1 in one control area, and hierarchically arranging the non-icon display area centered around the icon display area, the method comprises setting a maximum width of the non-icon display area being a minimum distance between two adjacent icon display areas.

6. The method for implementing a touch interface of claim 5, wherein the step of executing the corresponding command respectively if touch operations happen within the coordinates of the icon display area and the non-icon display area comprises:
collecting touch coordinates when the touch operation happens in the control area;
determining in which control area does the touch operation happen according to a minimum distance of the distances between the touch coordinates and the geometric centers of the adjacent control areas;
executing the command corresponding to the icon display area if the command corresponding to the non-icon display area is the same as the command corresponding to the icon display area; and
determining a specific area where the touch operation happens according to the touch coordinates and executing the corresponding command if the command corresponding to the non-icon display area is different from the command corresponding to the icon display area.

7. The method for implementing a touch interface of claim 6, wherein before the step of determining in which control area does the touch operation happen according to a minimum distance of the distances between the touch coordinates and the geometric centers of the adjacent control areas, the method further comprises:
prompting implementing the touch operation again if the number of the minimum distance is equal to or larger than 2.

8. A touch interface device comprising:
a display module, configured to provide a display area and screen coordinates and receive a touch operation;
a control module, connected with the display module and configured to control an area division, an image output and a display area arrangement of the display module;
a programming module, respectively connected to the display module and the control module and configured to store and execute a command program, wherein the programming module receives the touch coordinates sent by the display module is and execute the command corresponding to a control item according to the touch coordinates, and operate the control module;
wherein the display module comprises:
a screen unit, configured to display icons and data information and receive the touch operation;
a coordinate unit, connected with the screen unit and configured to establish a coordinate system for the screen unit, collect touch coordinates and output the touch coordinates;
a communication unit, respectively connected to the coordinate unit, the control module and the programming unit and configured to provide a data link to the coordinate unit, the control module and the programming unit; and
a driving unit, configured to drive the screen unit to display icons and data information;
the control module comprises:
an area unit configured to divide the display module into a control area, an icon display area and a non-icon display area according to the coordinate system; and
the communication unit, respectively connected to the area unit, the programming unit and the display module and configured to provide the data link to the area unit, the programming unit and the display module;
the programming unit comprises:
a storage unit, configured to store the control item and the command;
an executing unit, connected to the storage unit and configured to execute the corresponding command stored in the storage unit according to the touch coordinates collected by the display module and coordinate ranges of the control area, the icon display area and the non-icon display area divided by the control module; and
the communication unit, respectively connected to the executing unit, the control module and the display module and configured to provide the data link to the executing unit, the control module and the display module.

9. The touch interface device of claim 8, wherein the control module further comprises a hierarchy judging unit configured to set and judge the non-icon display areas arranged hierarchically in the adjacent control areas.

10. The touch interface device of claim 9, wherein the programming module further comprises a coordinate processing unit configured to calculate the coordinate of a geometric center, and control and judge a touch operation.
